(19) United States
(12) Patent Application Publication
(10) Pub. No.: US 2014/0136988 A1
(43) Pub. Date: May 15, 2014

(54) METHOD AND APPARATUS FOR SWITCHING DATA ADD-POSITIONS-TO CARRY DATA IN EMAIL

(71) Applicant: Samsung Electronics Co., Ltd., Gyeonggi-do (KR)

(72) Inventor: Dongho JANG, Gyeonggi-do (KR)

(73) Assignee: Samsung Electronics Co., Ltd., Gyeonggi-do (KR)

(21) Appl. No.: 14/069,953

(22) Filed: Nov. 1, 2013

(30) Foreign Application Priority Data
Nov. 12, 2012 (KR) 10-2012-0127197

(51) Int. Cl. H04L 12/58

(52) U.S. Cl. CPC H04L 51/08
USPC 715/752

(57) ABSTRACT

A method and apparatus for switching a data add region between a mail body region within an email and a file attach region within the email are provided. The method includes selecting, in response to a user input, one of data of an attached file from the file attach region and mail body data from the mail body regiont; receiving a data add region switching request; determining a data add region in response to the data add region switching request; and adding the selected data in the determined data add region.

### PRIORITY

This application claims priority under 35 U.S.C. §119(a) to a Korean Patent Application filed on Nov. 12, 2012 in the Korean Intellectual Property Office and assigned Serial No. 10-2012-0127197, the entire content of which is incorporated herein by reference.

### BACKGROUND OF THE INVENTION

1. Field of the Invention

The present invention relates generally to a method and apparatus for switching a data add region to carry data in an email and, more particularly, to a data add region switching method and apparatus for intuitively converting an attached file to mail body data and converting the mail body data to an attached file in composing an email.

2. Description of the Related Art

With the advance of digital technologies, various types of portable devices capable of supporting communication and processing information while users are on the move are being used. Such portable devices include cellular terminals, Personal Digital Assistants (PDAs), electronic organizers, smartphones, tablet Personal Computers (PCs), etc.

Recent portable devices feature various services and functions, such as voice telephony, text messaging (e.g., Short Message Service/Multimedia Message Service (SMS/MMS)), video conference, electronic organizer, photo shooting, emailing, broadcast playback, video playback, Internet access, electronic commerce, audio playback, scheduling, Social Networking Service (SNS), messenger, dictionary, gaming, etc.

Particularly, recent portable devices include functions allowing the user to access an Internet mail server to receive and transmit email, as well as radio communication and Internet access functions.

Portable devices enable users to connect to the Internet through radio communication networks, access email servers on the Internet to check emails, and compose an email using an email editor.

Accordingly, portable devices advantageously enable users to compose and transmit/receive emails anytime anywhere.

Typically, an email application is equipped with a function of attaching files to the email as well as a function of composing the email itself. In order to send a content item with the email, the corresponding file is attached to the email or inserted into the body of the email by selecting the corresponding file through menu list manipulation and browsing contents to retrieve the target file.

When a user intends to insert the attached file into the body of the email, it is necessary to perform the burdensome long process for inserting the file into the mail body (i.e., multiple steps of manipulating the menu list, browsing contents to retrieve the file to be inserted, selecting a menu for deleting the attached file).

As described above, the conventional method of inserting an attached file into a body of an email requires laborious manipulation for inserting the file that has been already attached to the email into the body of the email (i.e., inserting the corresponding file through the file insertion process and deleting the attached file).

However, the conventional method for switching between file insertion and file attachment requires laborious manipulations, especially when composing a business email requiring attachment and insertion of various multimedia files including pictures and videos.

Furthermore, portable devices, which are display size constrained, are also restricted in simultaneously browsing files and executing other functions during the email composition process, resulting in significant inconvenience for users.

Therefore, there is a need for a data add position switching method and apparatus that is capable of facilitating switching between attaching a file to the email and inserting the file in the body of the email.

### SUMMARY OF THE INVENTION

An aspect of the present invention addresses at least the above-described problems and provides at least the advantages provided below. An aspect of the present invention provides a user interface capable of executing and controlling an email composition browser function intuitively in a portable terminal.

Another aspect of the present invention provides a method and apparatus for facilitating execution and control of a mobile terminal function by simplifying the procedure of switching file insertion and file attachment in composing an email. That is, an aspect of the present invention is capable of reducing unnecessary user inputs in inserting the file attached to the email already into the body of the email or attaching the file inserted in the email body to the email, resulting in reduction of email composition time.

According to an aspect of the present invention, a method for switching a data add region between a mail body region within an email and a file attach region within the email is provided. The method includes selecting, in response to a user input, one of data of an attached file from the file attach region and mail body data from the mail body regiont; receiving a data add region switching request; determining a data add region in response to the data add region switching request; and adding the selected data in the determined data add region.

According to another aspect of the present invention, an apparatus for switching data a add region between a mail body region within an email and a file attach region within the email is provided. The apparatus includes a switching request reception module which receives a data add region switching request for one of data selected from among data of an attached file from the attached file region and mail body data from the mail body region; a data conversion module which converts the selected data to an other one of the attached file and the mail body data according to the data add region switching request; and a data insertion module which inserts the converted data in the switched data add region.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a block diagram illustrating the configuration of a portable terminal according to an embodiment of the present invention;

FIG. 2 is a diagram illustrating screens displayed in the procedure of transforming an email-attached file into mail body-inserted data in a portable terminal according to an embodiment of the present invention;

FIG. 3 is a diagram illustrating screens displayed in the procedure of transforming mail body-inserted data into an email-attached file in a portable terminal according to an embodiment of the present invention;

FIG. 4 is a schematic block diagram illustrating the configuration of an email-added data region switcher of a portable terminal according to an embodiment of the present invention;

FIG. 5 is a flowchart illustrating a method for switching a data add position from a mail body region to a file attach region in a portable terminal according to an embodiment of the present invention; and

FIG. 6 is a flowchart illustrating a method for switching a data add position from a file attach region to a mail body region in a portable terminal according to an embodiment of the present invention.

### DETAILED DESCRIPTION OF EMBODIMENTS OF THE PRESENT INVENTION

Embodiments of the present invention are described as follows with reference to the accompanying drawings in detail. The same reference numbers are used throughout the drawings to refer to the same or like parts. Detailed description of well-known functions and structures incorporated herein may be omitted to avoid obscuring the subject matter of the present invention.

The configuration and operation control method of the portable terminal according to embodiments of the present invention are described hereinafter with reference to the accompanying drawings. The configuration and operation control methods of the portable terminal according to embodiments of the present invention are not limited to the description made herein but can be applied to various embodiments. In the following, the description is directed to examples of hardware approach. However, since embodiments of the present invention include the technologies using both the hardware and software, embodiments of the present invention do not exclude software-based technologies.

According to an embodiment of the present invention, a portable terminal may be any of all the types of information communication devices and multimedia devices including a tablet PC, a cellular terminal, a mobile phone, a Personal Digital Assistant (PDA), a smartphone, an International Mobile Telecommunication (IMT) 2000 terminal, a Code Division Multiple Access (CDMA) terminal, a Global System for Mobile communication (GSM) terminal, a General Packet Radio Service (GPRS) terminal, an Enhanced Data GSM Environment (EDGE) terminal Universal Mobile Telecommunication Service (UMTS) terminal, a Digital Broadcast receiver, an Automated Teller Machine (ATM), etc.

Particularly, according to embodiments of the present invention, a portable terminal enters a writing gesture input mode, executes a function corresponding to a portable terminal item selected by a user's writing gesture made on the touchscreen, and controls the function execution of the portable terminal item according to various writing gestures.

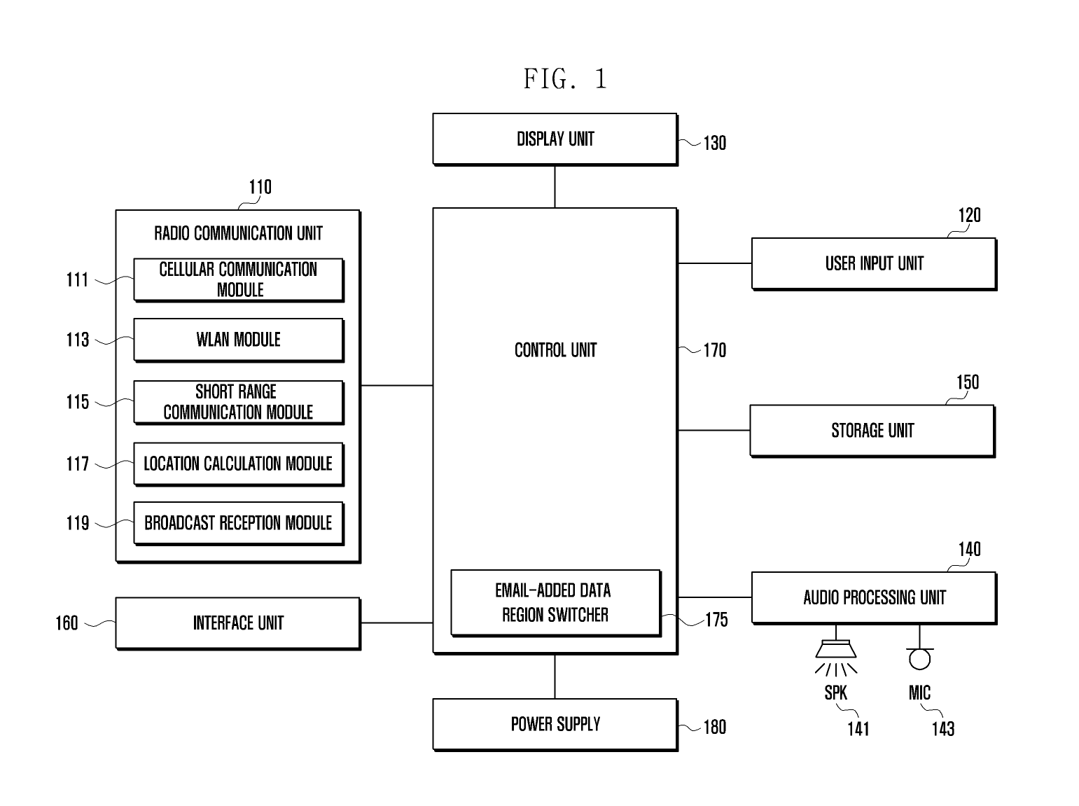

FIG. 1 is a block diagram illustrating the configuration of a portable terminal according to an embodiment of the present invention.

Referring to FIG. 1, a portable terminal according to an embodiment of the present invention includes a radio communication unit 110, an input unit 120, a display unit 130, an audio processing unit 140, a storage unit 150, an interface unit 160, a control unit 170, and a power supply 180. The portable terminal may be implemented with or without any of the components depicted in FIG. 1 and may further include other components (not shown). For example, a portable terminal according to an embodiment of the present invention may support only media content playback functions (i.e., communication functions and the radio communication unit 110 may be omitted).

Particularly, the portable terminal may be implemented to perform a transformation between the data inserted in the body of the email and the file attached to the email directly.

According to an embodiment of the present invention, the data inserted into the email body and the file attached to the email may represent a specific function, included data, or an object executing a sub-menu; and the data can be provided in various types of Graphic User Interface (GUI) such as text, icon, icon list, widget, and any combination thereof.

Radio communication unit 110 includes at least one module providing radio communication between the portable terminal and a radio communication system or between the portable terminal and a network on which another portable terminal is connected. For example, the radio communication unit 110 may include a cellular communication module 111, a Wireless Local Area Network (WLAN) module 113, a short-range communication module 115, a location calculation module 117, and/or broadcast reception module 119.

The cellular communication module 111 communicates through radio signals with at least one of a base station, an external terminal, and a server on the cellular communication network. The radio signals may include voice telephony signals, video-conference signals, and data of text/multimedia messages. The cellular communication module 111 is capable of accessing an external content server to download the media content selected by the user under the control of the control unit 170.

The WLAN module 113 accesses wireless Internet and establishes a WLAN link with another portable terminal and can be embodied within the portable terminal itself or attached to the portable terminal in the form of an external device. Wireless Internet access may be formed using one of various wireless Internet technologies including Wi-Fi, Wireless Broadband (WiBro), World Interoperability for Microwave Access (WiMax), and High Speed Downlink Packet Access (HSDPA).

The WLAN module 113 accesses the content server to download the media content selected by the user under the control of the control unit 170. The WLAN module 113 also establishes a WLAN link with another portable terminal to transmit and receive media content to and from the other portable terminal according to the user's manipulation. The WLAN module 113 also transmits the media content selected by the user to a cloud server through the WLAN connection or receiving the media content from the cloud server.

The short-range communication module 115 performs short-range communication. There are various short range communication technologies including Bluetooth, Radio Frequency Identification (RFID), Infrared Data Association (IrDA), Ultra Wideband (UWB), ZigBee, Near Field Communication (NFC), etc. The short-range communication module 115 transmits and receives multimedia content to and from another portable terminal through a short-range communication channel according to the user's manipulation.

The location calculation module 115 acquires location information on the portable terminal and representative via a Global Positioning System (GPS) module (not shown). The location calculation module 115 acquires distance information and accurate time information from at least three base stations and calculates a 3-dimensional current location with latitude, longitude, and altitude through triangulation based on the calculated information. Alternatively, the location calculation module 115 may receive current location information of the portable terminal from at least three satellites to calculate the location information. The location information of the portable terminal can be acquired in various methods in accordance with embodiments of the present invention.

The broadcast reception module 119 receives the broadcast signal from an external broadcast management server through a broadcast channel (e.g., a satellite channel and a terrestrial wave channel) and/or the information associated with the broadcast (e.g., a broadcast channel, a broadcast program, and broadcast service provider information).

The input unit 120 generates input data for controlling operations of the portable terminal in response to the user input. The input unit 120 may be implemented with at least one of a keypad, a dome switch, a touchpad (resistive/capacitive), a jog wheel, and a jog switch, for example. The input unit 120 may be implemented in the form of buttons outside of the portable terminal, and some buttons may be presented on the touch panel.

The display unit 130 displays (outputs) information processed in the portable terminal. For example, when the portable terminal is operating in the telephony mode, the display unit 130 displays a User Interface (UI) or Graphic UI (GUI) associated with the telephony mode. When the portable terminal is operating in a video conference mode or photo shooting mode, the display unit 130 displays a picture photographed with a camera and/or received from an external source, or through UI/GUI.

The display unit may be implemented with any of Liquid Crystal Display (LCD), Thin Film Transistor LCD (TFT LCD), Light Emitting Diode (LED), Organic LED (OLED), Active Matrix OLED (AMOLED), flexible display, bended display, and 3-dimensional (3D) display, for example. Some of these display panels may be implemented in the form of transparent displays.

When the display unit 130 is integrated with a touch panel for detecting touch gestures in a layered structure (hereinafter, referred to as touchscreen), the display unit 130 may operate as an input device as well as output device. The touch panel converts the pressure applied to a certain position on the display unit 130 or a change in capacitance at a certain position with respect to an electric input signal. The touch panel may detect the touch pressure as well as position and size of the touched position. If a touch gesture is made on the screen, the touch panel generates signals corresponding to a touch controller (not shown). The touch controller processes the signal(s) and then outputs the corresponding data to the control unit 170. The control unit 170 checks the position where the touch gesture is made on the screen of the display unit 130.

According to an embodiment of the present invention, the touch screen displays email being composed by the user in order for the user to check the composed email, receives the input for transforming between the attached file and inserted data, and displays the attached file and/or email body on the screen.

The audio processing unit 140 transfers the audio signal including voice from the control unit 170 to the speaker 141 and supplies the audio signal including voice input through the microphone 143 to the control unit 170. The audio processing unit 140 converts the voice/sound data to output through the speaker 141 into the form of audible sound wave and converts the audio signal including voice received through the microphone 143 into digital signal to the control unit 170 under the control of the control unit 170.

The speaker 141 outputs audio data received in the telephony mode, recording mode, media content playback mode, and broadcast mode, and/or stored in the storage unit 150. The speaker 141 outputs audio signals related to functions executed in the portable terminal (e.g., receiving incoming call, placing outgoing call, playing a music file, and playing a video file).

The microphone 143 processes the audio signal received from an external source to generate electrical voice data in the telephony mode, recording mode, speech recognition mode, and photo shooting mode. The processed voice data is converted into a format transmittable to a cellular communication base station through the cellular communication module 111 in the telephony mode. The microphone 143 may be implemented with various noise canceling algorithms for removing the noise added in receiving the external audio signal.

The storage unit 150 stores programs associated with the data processing according to operation of the control unit 170 and inputs/outputs data (e.g., phone number, message, audio, media contents, such as audio and video files, and electronic books). The storage unit 150 may store information such as utilization frequency (e.g., application utilization frequency, media content playback frequency, phone number utilization frequency, message utilization frequency, and multimedia utilization frequency), importance, and priority (preference). The storage unit 150 also may store various patterns of vibration and sound data output in response to the touch input made on the touchscreen. Particularly, the storage unit 150 may store media contents classified in association with property information (e.g., mood information).

The storage unit 150 also may store location information regarding the classification of media contents. The storage unit 150 may store the media contents that are grouped by similar properties (e.g., a mood property). The storage unit 150 also may store at least one program executing a function related to media content playback.

The storage unit 150 may be implemented with at least one of various types of storage media including flash memory, hard disk, micro card memory (e.g., Secure Digital (SD) and eXtreme Digital (XD) cards), Random Access Memory (RAM), Static RAM (SRAM), Read-Only Memory (ROM), Electrically Erasable Programmable ROM (EEPROM), Programmable ROM (PROM), Magnetic RAM (MRAM), magnetic disk, and optical disk. The portable terminal may operate in connection with web storage responsible for Internet storage functions of the storage unit 150.

Particularly, according to an embodiment of the present invention, the storage unit 150 may store the data inserted in an email body and files attached to the email before and after transformation of the inserted data and metadata of the inserted data including type, name, creation date, size, location, etc.

For this purpose, the storage unit 150 may be provided with a mail body database, an attached file database, and a mapping table database. The mail body database may store the mail body data before and after transformation, the attached file database may store the attached files before and after transformation. The mapping table database may store the mapping tables mapping the attached file formats and the email body-inserted data formats. The interface unit 160 provides a connection interface for different types of external devices to the terminal. The interface unit 160 makes it possible to transmit and receive data to and from an external device and supply power to the internal components of the portable terminal. For example, the interface unit 160 may include at least one of a wired/wireless headset port, an external charging port, a wired/wireless data port, a memory card slot, an identity module-equipped device connection port, an audio Input/output port, a video input/output port, an earphone port, etc.

The control unit 170 controls overall operations of the portable terminal. For example, the control unit 170 may control the operations related to the voice telephony, data communication, and video-conferencing.

According to an embodiment of the present invention, the control unit 170 includes email-added data region switcher 175. The email-added data region switcher 175 may be implemented in the control unit 170, or as an entity separated from the controller 170.

Detailed control operations of the email-added data region switcher 175 are described later herein with reference to the accompanying drawings.

The power supply 180 supplies the power from an external or internal power source to the components of the portable terminal under the control of the control unit 170.

The above-described embodiments of the present invention can be implemented by hardware, firmware, software, or a combination thereof. When implementing embodiments of the present invention through hardware, embodiments of the present invention can be implemented with Application Specific Integrated Circuits (ASICs), Digital Signal Processors (DSPs), Digital Signal Processing Devices (DSPDs), Programmable Logic Devices (PLDs), Field Programmable Gate Arrays (FPGAs), a processor, a controller, a microcontroller, or a microprocessor, etc. In any case, embodiments of the present invention can be implemented through use of the control unit 170. When implementing embodiments of the present invention by software, the procedures and/or functions described herein can be implemented with separate software modules. The software modules are capable of performing at least one function and operation described herein.

Although not depicted in FIG. 1, a portable terminal according to embodiments of the present invention may include other components that not enumerated above, such as a camera module for shooting a scene to acquire video data, a short range communication module for short range communication, an Internet access module for establishing connection to the Internet, a digital broadcast module for receiving and playing broadcast signal, etc. Although not enumerated herein, a portable terminal according to an embodiment of the present invention may selectively include other components equivalent to the aforementioned components, according to digital device convergence. Also, a portable terminal an embodiment of the present invention can be implemented with or without any of the aforementioned components or with any replacement for each component.

A description of an operation method of a portable terminal according to an embodiment of the present invention is provided as follows. Since embodiments of the present invention are not limited to the specific details of the following description, various modifications could be made, in accordance with embodiments of the present invention.

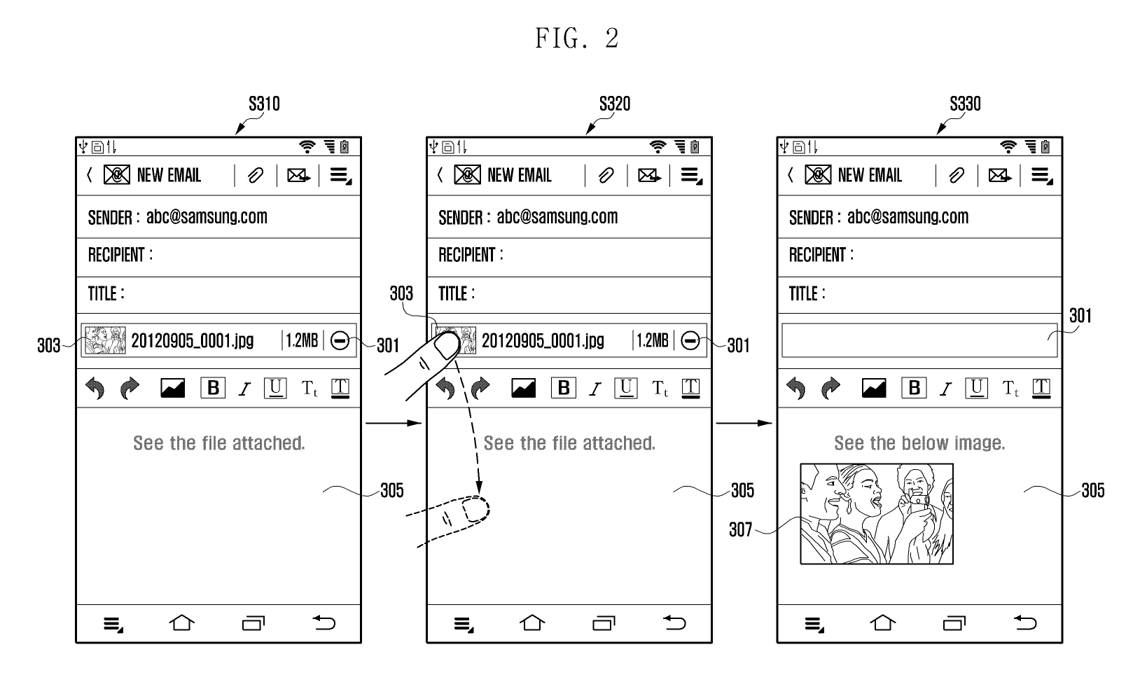

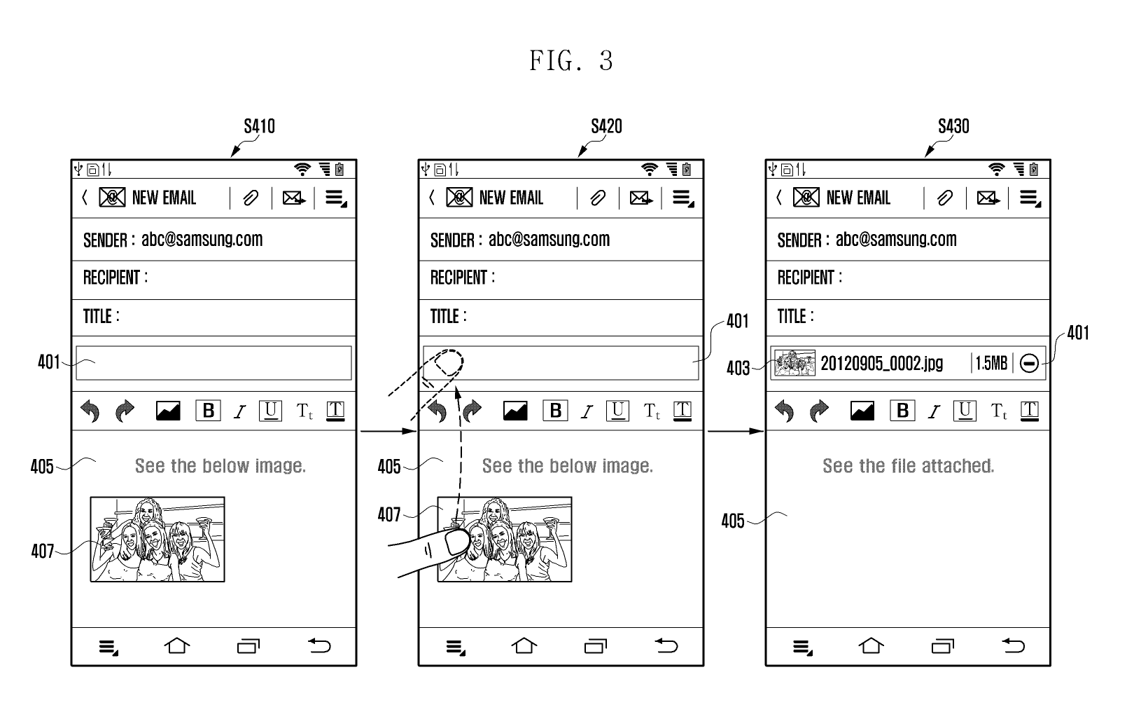

Hereinafter, an operation of transformation between email-body inserted data and email-attached file in the portable terminal according to an embodiment of the present invention is described in detail with reference to FIGS. 2 and 3.

Hereinafter, an operation of transformation from a file attached to email to data inserted in the body of the email is described in detail with reference to FIG. 2.

FIG. 2 is a diagram illustrating screens displayed in a procedure of transforming an email-attached file to a mail body-inserted data in a portable terminal according to an embodiment of the present invention.

Referring to FIG. 2, reference number S310 denotes a screen (i.e., an email application execution screen) of a portable terminal in a state in which an email application is executed. That is, reference number S310 shows a screen of a mail composition browser.

As shown in screen S310, at least one file attached to the email is presented in the file attach region 301 of the mail composition browser. As shown in screen S320, a user may drag a file from the file attach region 301 and drop the file into the mail body region 305 to insert the attached file in the body of the email.

After the file is dropped into the mail body region 305, the portable terminal transforms the file 303 attached to the email in the file attach region 301 into data inserted in the mail body region 305.

In this way, an embodiment of the present invention allows the user to convert the attached file placed in the file attach region 301 to data inserted in the mail body region 305. The file placed in the file attach region 301, may be deleted or left without deletion according to a user's request.

As shown in screen S320, the user may select at least one attached file to transform the selected file to the body-inserted data. When a plurality of attached files are selected, the portable terminal may transform the mail-attached files into the mail body-inserted data in series or simultaneously.

As an example of the attached file 303 in screen S320, the image file can be attached in one of various image file formats including bitmap, GIF, JPEG, JPG, etc. Such an image data may be inserted into the mail body in one of the aforementioned image file formats. At this time, the image data size can be adjusted to a predetermined size suitable for being inserted into the mail body region 305.

The attached file may be any of all the types of files attachable to the email such as image files, audio files, video files, flash file, execution file, and other OA program files.

The file extension of the attached file may be any of HWP, JPG, DOC, EXL, WMV, BMG, PDF, etc. The attached file corresponding to the corresponding audio data may have one of various extensions including MP3, MP4, WMA (Window Media Audio), ASF (Advanced System Format), OGG, RM, RA, etc. The attached file corresponding to video data may have one of various extensions including MPEG, AVI, WMV, MOV, MP4, K3G, SWF, DAT, VCD, etc.

When the data format of the attached file is of data that can be inserted in the mail body region 305 itself, the portable terminal may insert the data of the attached file in the mail body region 305 without any conversion process. Such files may include text files, image files, and various OA program files.

In order to accomplish this insertion, the portable terminal retrieves the attached file from the corresponding database to generate the data to be inserted in the mail body from the retrieved file and inserts the generated data in the mail body region 305, such that the file attached to the mail is converted into the data inserted directly into the mail body.

When the data format of the attached file is of data that cannot be inserted in the mail body region itself, the portable terminal may convert the data of the attached file to a predetermined format, such that the converted data can be inserted in the mail body region 305.

Such files may include audio files, video files, flash files, execution files, and other OA programs files.

For example, the data that cannot be inserted in the mail body region 305 without conversion may be replaced by the information corresponding to the data, such as a link address, an execution icon, a file extension of the data, a data name, a creation date, a data size, and a stored location.

Here, the process of generating the attached file in the form of information on the data (i.e., data that can be inserted in the mail body), such as link address and execution icon, and converting the information to the data format that can be inserted in the mail body, is included in the data conversion procedure.

Although screen S320 is directed to an example in which the user performs a drag and drop input to transform the attached file to the mail body-inserted data, embodiments of the present invention are not limited thereto, but can also be implemented with various input methods such as copy and paste, full down menu selection with click, sound/speech recognition, and any combination thereof.

FIG. 3 is a diagram illustrating screens displayed in a procedure of transforming the mail body-inserted data to an email-attached file in the portable terminal according to an embodiment of the present invention.

Referring to FIG. 3, reference number S410 denotes a screen (i.e., an email application execution screen) of the portable terminal in which an email application (hereinafter, referred to as “mail”) is executed. Accordingly, reference number S410 shows a screen of a mail composition browser.

For example, if an email execution command is input by the user, the email application execution screen is displayed.

The email composition browser may be an email composition browser provided by a normal web server.

As shown in FIG. 3, the email execution screen includes an indicator region providing information on an operation state of the portable terminal (e.g., communication state information and batter information, and time information), a sender indication region, a recipient indication region, a title region, a file attach region 401, and a mail body region 405.

According to an embodiment of the present invention, since the depicted components included the mail execution screen of FIG. 2 are not all mandatory, the mail execution screen may be implemented with various types of User Interfaces (Uis) or Graphical UIs (GUIs) with or without at least one of the components depicted in FIG. 3.

The mail body region 405 may be filled with text including symbols, characters, numbers, and figures according to the user input. The mail body region 405 may include an image in a predetermined size and items such as links and execution icons capable of executing corresponding multimedia data, such as video and audio files.

Referring to FIG. 3, in screen S410, the mail body region 405 includes the text ‘See the below image’ and the image data 407 is inserted below the text.

According to an embodiment of the present invention, it is possible to transform the data inserted in the mail body region 405 into a corresponding attached file.

As shown in screen S420, the user may drag the image data 407 inserted in the mail body region 405 and drop the file in attach region 401.

As shown in screen S430, when the image data 407 is dropped in the attach region 401, the portable terminal transforms the image data 407 which was previously inserted in the mail body region 405 to an attached file in the file attach region 401.

In this way, according to an embodiment of the present invention, a user is able to convert the data inserted in the mail body to the attached file placed in the file attach region 401 by performing a gesture or input. In performing this operation, the data inserted in the mail body region 405 may be deleted or remain without deletion, according to the user request.

As shown in screen S420, a portion or all of the mail body 405 may be selected, such that a portion or all of the data of the mail body is transformed into attachments, in response to the user request.

The portable terminal is capable of transforming a plurality data in series, or simultaneously, according to a user's request.

Although screen S420 is directed to an example in which the user performs a drag and drop input to transform the data inserted in the mail body 405 into an attached file, embodiments of the present invention are not limited thereto, but can be implemented with various input methods such as copy and paste, full down menu selection with click, sound/speech recognition, and any combination thereof.

Although not depicted in FIG. 3, according to an embodiment of the present invention, if the text data of ‘See the blow image’ is dragged and dropped into the file attach region 401, the text data is transformed to a text file so as to be placed in the file attach region 401 as attached to the email.

In FIG. 3, the image data 407 can be attached in one of various image file formats including bitmap, GIF, JPEG, JPG, etc., so as to be put into the file attach region 401, and the file size can be adjusted to a predetermined size.

If the user selects a link address or an execution icon for executing multimedia data such as video, flash animation, and audio inserted in the body of the email to request for transformation, the portable terminal transforms the video or audio data represented by the link address or execution icon into an attached file.

In order to accomplish this transformation, the portable terminal retrieves the data inserted in the mail body from the database to generate an attached file with the retrieved data and puts the generated attached file in the file attach region 401, such that the data inserted in the mail body is converted into the attached file.

At this time, the portable terminal converts the mail body data selected by the user to a file format having a predetermined extension and attaches the converted file to the email. The attached file may have one of various extensions including, HWP, JPG, DOC, EXL, WMV, BMG, PDF, etc.

The attached file corresponding to audio data may have one of various extensions including MP3, MP4, WMA (Window Media Audio), ASF (Advanced System Format), OGG, RM, RA, etc.

The attached file corresponding to video data may have one of various extensions including MPEG, AVI, WMV, MOV, MP4, K3G, SWF, DAT, VCD, etc.

Accordingly, the attached file may be any of all the types of files attachable to the email such as image files, audio files, video files, flash file, execution file, and other OA program files. The OA programs include Hun Min Jiyung Um, Hangul, Word, Excel, etc.

Hereinafter, an email-added data region switching apparatus according to an embodiment of the present invention is described as follows.

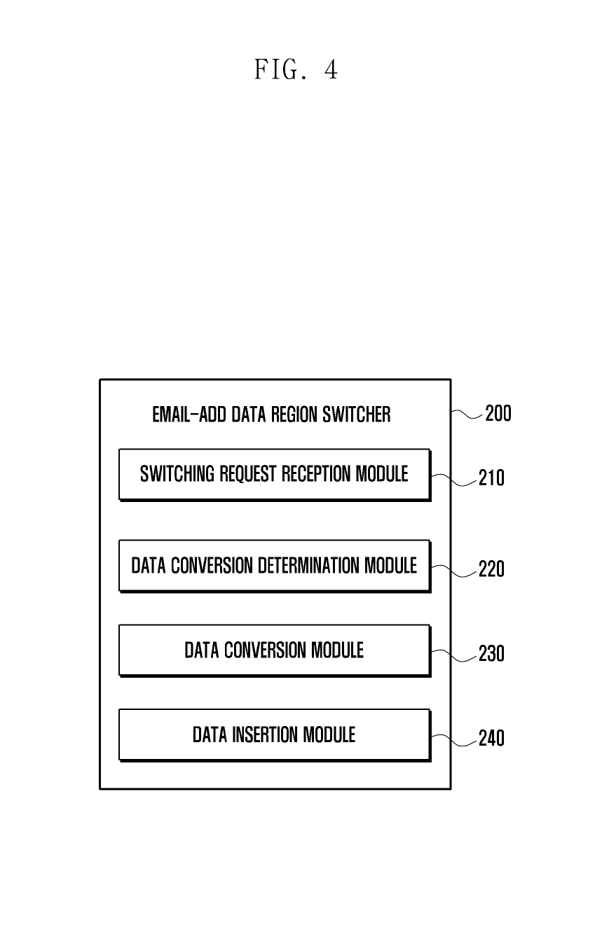

FIG. 4 is a schematic block diagram illustrating a configuration of an email-added data region switcher of the portable terminal according to an embodiment of the present invention.

Referring to FIG. 4, the email-added data region switcher 200 of the portable terminal according to an embodiment of the present invention includes a switching request reception module 210, a data conversion determination module 220, a data conversion module 230, and a data insertion module 240.

The switching request reception module 210 receives a email-added data region switching request for an item selected in at least one of the file attach region and the body of an email.

The email-added data region may be either one of the file attach region or the mail body region.

Accordingly, the switching request reception module 210 receives the switching request for inserting the attached file in the body of the email as corresponding data or attaching the mail body data to the mail as a file. The switching request may be input by the user.

The email-added data region switching request may be input through drag and drop, copy and paste, full down menu selection with click, sound/speech recognition, and any combination thereof, but is not limited thereto.

The data conversion determination module 220 determines whether it is possible to convert the data format of the selected data to the format supported in the email body.

More specifically, the data conversion determination module 220 determines whether the data selected by the user in the mail body has the data format convertible to a file attachable the email or determines whether the attached file selected by the user has the data format convertible to the data to be inserted in the mail body.

After a determination that it is impossible to convert between the mail body data and the attached file, a conversion impossibility notification message is output. For example, the mail browser may display a pop-up window including text such as “data conversion is impossible.”

The data conversion module 230 converts the data determined to be convertible by the data conversion determination module 220 to the attached file or mail body-inserted data.

Accordingly, the data conversion module 230 converts the attached file to the mail body-inserted data or vice versa.

More specifically, the target data format of the mail body data or the attached file to be converted may be determined by referencing the preconfigured mapping table. The data conversion module 230 searches the mapping table for the target data format and converts the mail body data or the attached file to the data format. The mapping table may be stored in the mapping table database.

Here, the mapping table is classified into one of a first mapping table for conversion from mail body data to attached file and a second mapping table for conversion from the attached file to mail body data.

For example, the first mapping table maps mail body data formats of bitmap, GIF, JPEG, and JPG, for example, to file formats of attached files. The first mapping table may also map an execution icon capable of executing the link address, video, flash, and audio to the corresponding video, flash, and audio files, such that the files are generated as attached file.

In order to accomplish this generation of an attached file, the data conversion module 230 retrieves the data inserted in the mail body from the corresponding database to generate the attached file, and puts the generated file in the file attach region, such that the mail body data is directly converted to the attached file.

The data conversion module 230 retrieves the data of the attached file from the corresponding database to generate the mail body-inserted data (i.e., data to be inserted into the mail body) and inputs the generated data in the mail body region such that the attached file is converted to the mail body-inserted data.

The data insertion module 240 may insert the converted data in the data add region according to a user request. Accordingly, the data insertion module 240 puts a file converted from the mail body data in the file attach region of the email composition browser. The data insertion module 240 also inserts the data converted from an attached file in the email body region of the email composition browser.

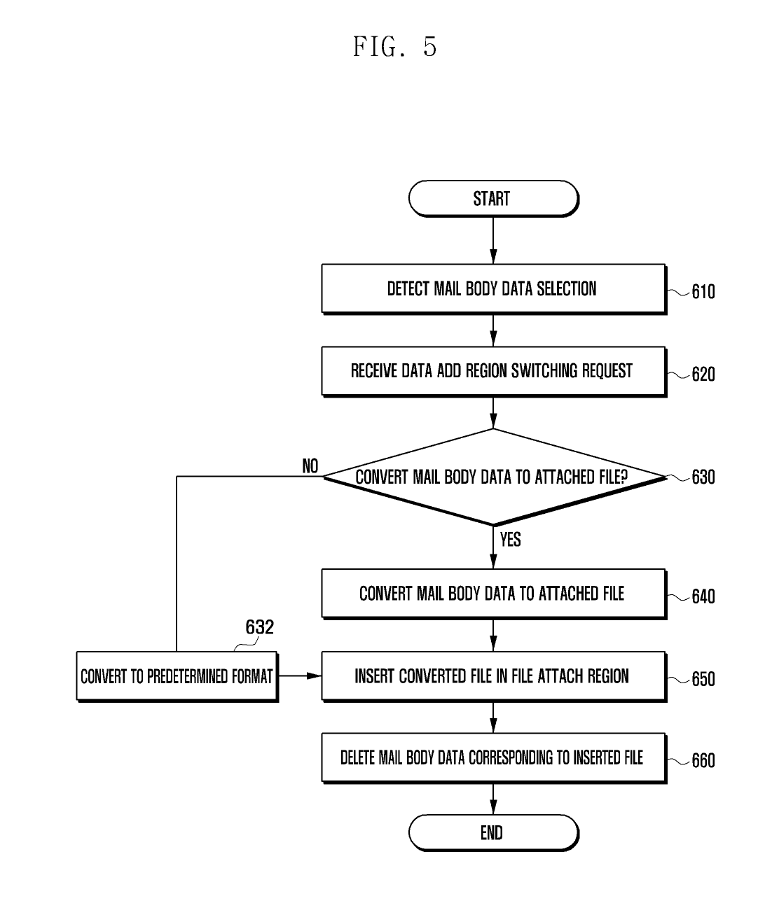

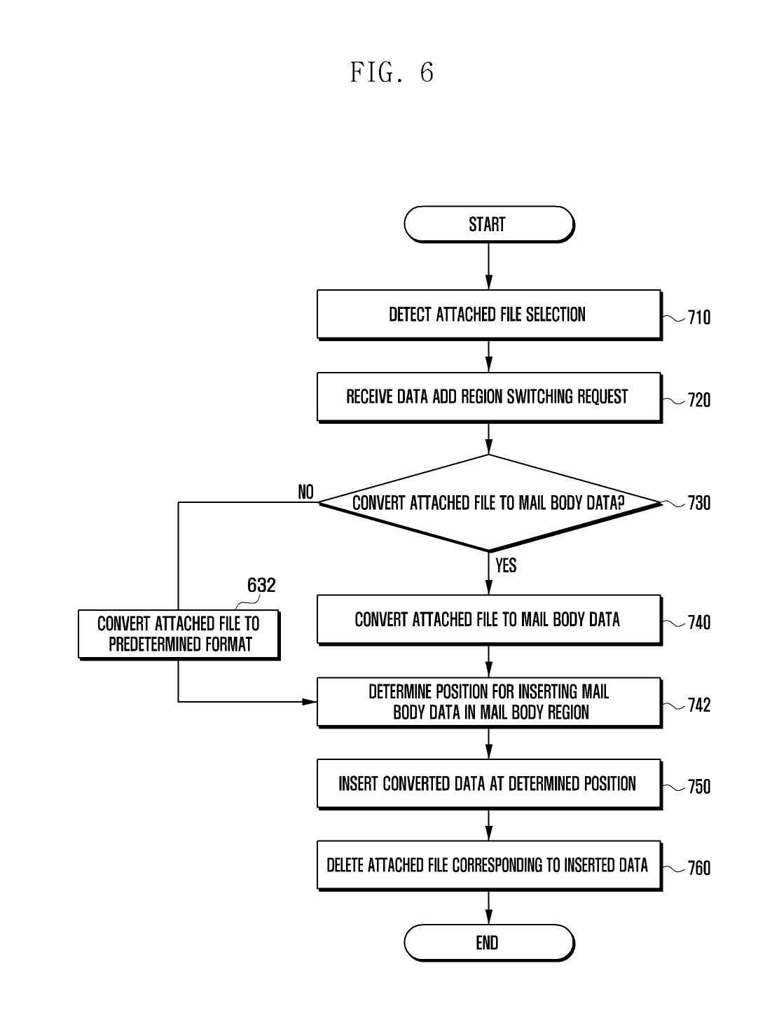

An email-added data region switching method according to an embodiment of the present invention is described in detail as follows with reference to FIGS. 5 and 6.

FIG. 5 is a flowchart illustrating a method for switching the data add position from the mail body region to the file attach region in the portable terminal according to an embodiment of the present invention.

Referring to FIG. 5, the control unit 170 detects data selected in the body for the email, at step 610. More specifically, the control unit 170 detects the data selected by the user from among data inserted in the mail body region, in the middle of composing the email. For example, while composing an email, the user may select only a portion of or all data of the email body.

The control unit 170 receives a data add region switching request for the data selected in the email body, at step 620. More specifically, the control unit 170 receives the user request for switching the data add region from the mail body region to the file attach region. The data add region switching request of the user may be made in various input methods such as drag and drop, copy and paste, and full down menu selection with click, sound/speech recognition, and any combination thereof, but embodiments of the present invention are not limited thereto.

For example, the user may select a part of the body of the mail with a cursor, and drag and drop the selected part in the file attach region, such that the data add region is switched from the mail body region to the file attach region.

If a request for switching data add region from the mail body region to the file attach region is received, the control unit 170 determines whether it is possible to convert the email body data to the attached file, at step 630. More specifically, the control unit 170 determines whether the selected email body data can be converted to the attached file.

If it is determined that the selected mail body data can be converted to the attached file at step 630, the control unit 170 converts the mail body data to the attached file, at step 640. In this case, the selected mail body data is loaded from the original location, i.e., a database, as the attached file.

In addition to, or as an alternative to the conversion process, the control unit 170 is also capable of parsing the selected mail body data to generate a contact file and/or memo file according to the type of the selected mail body, at step 640.

For example, the parsed data such as image and text of the mail body can be processed to generate a memo file by loading the data as attached file immediately. More specifically, the mail body data can be loaded as the attached file from its original storage location (e.g., a database), without converting the data format.

In another process according to an embodiment of the present invention, the data such as phone number, email address, flash, video, and audio execution icons of the mail body analyzed through parsing can be converted to a contact file. More specifically, a phone number in the mail body can be converted into a contact file capable of executing the telephony application, a email address in the mail body can be converted into a contact file for executing the mail application, and video, flash and audio execution icons can be converted into files for executing the corresponding players.

The video, flash, and audio data in the mail body are loaded from their original locations (e.g., a database) to generate the attached file.

The attached file can be any of all the types of files (e.g., image file, audio file, video file, flash file, execution file, and other OA program files). An attached file corresponding to audio data may have one of various extensions including MP3, MP4, Window Media Audio (WMA), Advanced System Format (ASF), OGG, RM, RA, etc. The attached file corresponding to video data may have one of various extensions including MPEG, AVI, WMV, MOV, MP4, K3G, SWF, DAT, VCD, etc. The attached file corresponding to OA program file may have one of various extensions including DOC, EXL, HWP, etc.

If the mail body data is converted to an attached file at step 640, the control unit 170 puts the attached file in the file attach region at step 650. More specifically, the control unit 170 places the attached file converted from the mail body data in the file attach region of the mail composition browser.

If the converted file is attached to the mail at step 650, the control unit 170 deletes the corresponding data from the mail body region at step 660.

Step 660 is optional, such that the user can select whether to delete the data in the mail body region. More specifically, the data corresponding to the attached file may be deleted from the mail body region or left remaining in the mail body region without deletion in the mail composition browser, after the attachment of the file in the file attach region.

If it is determined that the selected mail body data cannot be converted to an attached file at step 630, the control unit 170 converts the body data to a predetermined format at step 632.

For example, if the selected data is data that can be inserted in the mail body, but that cannot be transformed into an attached file, the control unit 170 converts the mail body data to a predetermined format. At this time, the predetermined format is any file format having any of various file extensions including DOC, EXL, WMV, BMG, PDF, etc., and the file may contain information regarding the mail body data. The information regarding the mail body data may include storage location, extension, data name, creation date, and data size of the mail body data, for example, but embodiments of the present invention are not limited thereto.

Once the mail body data is converted into an attached file, at step 632, the control unit 170 attaches the converted data to the mail so as to be shown in the file attach region, at step 650.

If the converted data is attached to the mail so as to be shown in the file attach region at step 650, the control unit 170 deletes the data corresponding to the attached file from the mail body region at step 660.

As described, above, step 660 is optional, execution or non-execution of this step is performed according to the user settings. More specifically, after the converted file is attached to the mail, the mail body data corresponding to the attached file may be deleted from the mail body region or left in the mail body region without deletion.

The method for switching the data ad region from the file attach region to the mail body region is described hereinafter with reference to FIG. 6.

FIG. 6 is a flowchart illustrating a method for switching a data add position from a file attach region to a mail body region in a portable terminal according to an embodiment of the present invention.

Referring to FIG. 6, the control unit 170 detects selection of an attached file, at step 710. For example, the user selects at least one attached file while composing an email.

The control unit 170 receives a data add region switching request for the selected file, at step 720. In detail, the control unit 170 receives the user request for switching the file add region from the file attaché region to the mail body region. The file add region switching request may be made in any of various input methods including drag and drop, copy and paste, and full down menu selection with click, sound/speech recognition, and any combination thereof, but embodiments of the present invention are not limited thereto.

For example, the user may select an attached file with a cursor and drag and drop the selected file in the mail body region, such that the data add region is switched from the file attach region to the mail body region.

If a request for switching data add region from the file attach region to the mail body region is received, the control unit 170 determines whether it is possible to convert the attached file to the mail body data, at step 730. More specifically, the control unit 170 determines whether the selected file can be converted to the mail body data. For example, if the selected file is an image or text, the attached file can be changed into corresponding mail body data immediately without data format conversion process. If the attached file is video, flash, or audio file, the data format conversion is necessary, and the attached file is not immediately converted into the mail body data.

If it is determined that the attached file can be changed into mail body data at step 730, the control unit 170 converts the attached file into mail body data at, step 740.

At this time, the data of the attached file is loaded from its original storage location, e.g. database, to the mail body region.

The control unit 170 parses the selected file to generate data such as original data, link address, and execution icon according to the data type of the selected file.

For example, image and text data of the attached file analyzed through parsing can be immediately loaded to the mail body region, i.e., it is possible to loads the data of the attached file from its original storage location (e.g. a database) to the mail body region without a data format conversion process.

In another process according to an embodiment of the present invention, multimedia data such as video, flash, and audio data of the attached file, analyzed through parsing, can be processed to generate information regarding an execution icon, link address, and other corresponding data for executing the data. The information regarding the data may include data extension, data name, creation date, data size, storage location, etc.

The attached file can be any of all the types of files (e.g., image file, audio file, video file, flash file, execution file, and other OA program files) that can be attached in the mail composition browser. The mail body data can be any of all the types of data including image data, text data, and various OA program data that can be inserted in the mail body region of the mail composition browser.

The attached file corresponding to audio data may have one of various extensions including MP3, MP4, WMA (Window Media Audio), ASF (Advanced System Format), OGG, RM, RA, etc. The attached file corresponding to video data may have one of various extensions including MPEG, AVI, WMV, MOV, MP4, K3G, SWF, DAT, VCD, etc. The attached file corresponding to OA program file may have one of various extensions including DOC, EXL, HWP, etc.

If the attached file is converted to data that can be inserted in the mail body region at step 740, the control unit 170 determines the position where the converted data is inserted in the mail body region, at step 742.

More specifically, if the user selects a position in the mail body region, the control unit 170 determines the user-selected position as the position where the converted data will be inserted. The data insertion position can be any of, for example, a drag and drop position, a position touched in the state that the attached file is selected, or at a position selected with a navigation key of the portable terminal in a state in which the attached file is selected, and any combination thereof.

If the position where the converted data is inserted in the mail body region is determined at step 742, the control unit 170 inserts the converted data at the determined position in the mail body region at step 750. Accordingly, the control unit 170 is capable of inserting the converted mail body data in the mail body region of the mail composition browser.

If the converted data is inserted in the mail body region at step 750, the control unit deletes the attached file corresponding to the inserted data at step 760.

Step 760 is optional, and therefore may be executed selectively according to user settings. More specifically, the attached file corresponding to the converted data may be deleted from the mail composition browser maintained without deletion.

If it is determined that the attached file cannot be immediately converted to the mail body data, the control unit converts the attached file to a predetermined format, at step 732.

That is, the control unit 170 converts the attached file that not cannot be inserted in the mail body region in a predetermined format. Such a file having data that cannot be inserted in the mail body region immediately may be any of video, flash, and audio files, for example. The control unit 170 is capable of processing the files to generate a predetermined format such as execution icon and link address executable for the corresponding file.

At this time, the predetermined format is any file having any of various file extensions including DOC, EXL, WMV, BMG, PDF, etc., and the file may contain information on the mail body data. The information regarding the mail body data may include for example, storage location, extension, data name, creation date, and data size of the mail body data, but embodiments of the present invention are not limited thereto.

Once the attached file is converted to a predetermined format at step 732, the control unit 170 determines the position for inserting the converted data in the mail body region at step 742.

Next, the control unit 170 inserts the converted data at the determined position in the mail body region at step 750.

Once the converted data is inserted at the determined position of the mail body region at step 750, the control unit 170 may delete the attached file corresponding to the converted mail body data from the file attach region, at step 760, or may alternatively leave the file in the file attach region.

As described above, a data add region switching method and apparatus according to embodiments of the present invention converts an attached file in the file attach region of an email into composition data inserted in the mail body region, or converts data inserted in the mail body region into an attached file in the file attach region, without redundant or unnecessary processes. Accordingly, a data add region switching method and apparatus according to embodiments of the present invention is capable of switching the data add region from the file attach region to the mail body region or vice versa efficiently.

A data add region switching method and apparatus according to embodiments of the present invention advantageously simplifyies the data add region switching process, improves the user convenience in function execution and control of the portable terminal, and reduces mail composition time.

The above-described the data add region switching method and apparatus of the portable terminal according to embodiments of the present invention can be implemented in the form of computer-executable program commands and stored in a computer-readable storage medium. The computer readable storage medium may store the program commands, data files, and data structures in individual or combined forms. The program commands recorded in the storage medium may be designed and implemented for various exemplary embodiments of the present invention or used by those skilled in the computer software field. The computer-readable storage medium includes magnetic media such as a floppy disk and a magnetic tape, optical media including a Compact Disc (CD) ROM and a Digital Video Disc (DVD) ROM, a magneto-optical media such as a floptical disk, and the hardware device designed for storing and executing program commands such as ROM, RAM, and flash memory. The programs commands include the language code executable by computers using the interpreter as well as the machine language codes created by a compiler. The aforementioned hardware device can be implemented with one or more software modules for executing the operations of the various exemplary embodiments of the present invention.

Although embodiments of the invention have been described using specific terms, the specification and drawings are to be regarded in an illustrative rather than a restrictive sense in order to help understand the present invention. Various modifications and changes can be made thereto without departing from the broader spirit and scope of the invention, as defined by the appended claims and their equivalents.

What is claimed is:

1. A method for switching a data add region between a mail body region within an email and a file attach region within the email, the method comprising:
selecting, in response to a user input, one of data of an attached file from the file attach region and mail body data from the mail body regiont;
receiving a data add region switching request;
determining a data add region in response to the data add region switching request; and
adding the selected data in the determined data add region.

2. The method of claim 1, wherein the data add region switching request is performed through at least one of a drag and drop, a copy and paste, click-based full down menu, and sound/speech recognition.

3. The method of claim 1, further comprising determining whether the selected data is capable of being loaded in the data add region targeted by the data add region switching request from an original storage location.

4. The method of claim 1, wherein receiving the data add region switching request comprises requesting switching of the data add region from the mail body region to the file attach region.

5. The method of claim 4, further comprising converting, before adding the selected data in the determined data add region, the selected data to a data format capable of being added to the determined data add region.

6. The method of claim 5, wherein converting the selected data to the data format capable of being added to the determined data add region comprises:
generating, when the selected one of the data of the attached file is the mail body data, at least one of a contact file and a memo file by parsing the selected mail body data; and
converting the at least one of the contact file and the memo file to at least one attached file.

7. The method of claim 4, wherein the requested switching of the data add region from the mail body region to the file attach region comprises loading the mail body data in the file attach region from a database.

8. The method of claim 4, wherein the requested switching of the data add region from the mail body region to the file attach region comprises at least one of converting a phone number of the mail body data to a contact file usable in executing a telephony application, converting an email address of the mail body data to a contact file usable in executing an email application, and converting video, flash, or audio execution icons to a contact files usable in executing a corresponding player.

9. The method of claim 4, wherein the requested switching of the data add region from the mail body region to the file attach region comprises attaching, when the selected data is the mail body data, information indicating a data type and storage location of the mail body data to the attached file.

10. The method of claim 1, wherein the data add region switching request is a request for inserting the data of the attached file as the mail body data.

11. The method of claim 11, wherein receiving the data add region switching request comprises selecting a position for inserting the mail body data in response to a user input.

12. The method of claim 11, wherein the attached file is dragged from the file attach region and dropped into a User Interface (UI) of the mail body region, a touch is made in the UI of the mail body region in a state in which the attached file is selected, or the UI of the mail body region is selected by means of a navigation key of a terminal in state that the attached file is selected.

13. The method of claim 10, wherein determining the data add region comprises converting the attached file to the mail body data to be inserted to the mail body.

14. The method of claim 10, wherein determining the data add region comprises loading the data of the attached file in the mail body region from a database.

15. The method of claim 14, wherein determining the data add region comprises inserting, when the data of the attached file is image data, the image data in the mail body region, such that the image data is adjusted to a predetermined size.

16. The method of claim 14, wherein determining the data add region comprises inserting, when the data of the attached file is text data, the text data in the mail body region, such that the text data reflects an original form, font size, color, and effect.

17. The method of claim 14, wherein determining the data add region comprises inserting, when the data of the attached file is media data including video and audio, the media data in the mail body region in the form of a link for executing the media data.

18. The method of claim 1, wherein the selected data is added in the determined data add region according to a mapping table that designates data formats to which the mail body data and attached file are converted.

19. The method of claim 18, wherein determining the data add region comprises converting the selected data to another data format according to the mapping table.

20. An apparatus for switching a data add region between a mail body region within an email and a file attach region within the email, the apparatus comprising:
a switching request reception module which receives a data add region switching request for one of data selected from among data of an attached file from the attached file region and mail body data from the mail body region;
a data conversion module which converts the selected data to an other one of the attached file and the mail body data according to the data add region switching request; and
a data insertion module which inserts the converted data in the switched data add region.
